(19) United States
(12) Patent Application Publication
(10) Pub. No.: US 2023/0237550 A1
(43) Pub. Date: Jul. 27, 2023

(54) CONTENT SHARING METHOD FOR RELAY SERVER

(71) Applicant: Ju Ho YEOM, Busan (KR)

(72) Inventor: Ju Ho YEOM, Busan (KR)

(21) Appl. No.: 18/192,133

(22) Filed: Mar. 29, 2023

Related U.S. Application Data
(63) Continuation of application No. PCT/KR2020/013389, filed on Sep. 29, 2020.

(30) Foreign Application Priority Data
Sep. 29, 2020 (KR) 10-2020-0126962

(51) Int. Cl. G06Q 30/0601; G06Q 20/02; G06Q 10/02

(52) U.S. Cl. CPC G06Q 30/0613; G06Q 20/027; G06Q 10/02

(57) ABSTRACT

A content sharing method by which a relay server shares content between application management servers. According to the method: the relay server receives, from a first application management server for operating a first application, first content information that can be used through the first application; the relay server transmits the first content information to remaining application management servers; the relay server receives content purchase information including a purchase request and payment information, which is inputted through a second application, from a second application management server for operating the second application; the relay server provides the purchase request for the first content information to the first application management server; the relay server receives a purchase confirmation of the first content information from the first application management server; and the relay server transmits the purchase confirmation of the first content information to the second application management server.

### CROSS-REFERENCE TO RELATED APPLICATION

This application is a continuation of PCT/KR2020/013389, filed on Sep. 29, 2020, which claims priority to and the benefit of Korean Patent Application No. 10-2020-0126962, filed on Sep. 29, 2020, the disclosure of which is incorporated herein by reference in its entirety.

### TECHNICAL FIELD

The present invention relates to a content sharing method for a relay server.

### BACKGROUND ART

Today, users may make reservations for travel content through applications using their mobile terminals. Although there are multiple travel agencies, in general, most small travel agencies supply travel content stored in their databases to large travel agencies, and customers may book travel products only through applications operated by the large travel agencies. In this process, when the travel content is booked through the applications operated by the large travel agencies, there is a disadvantage in that the small travel agencies have to pay a substantial fee to the large travel agencies.

### DISCLOSURE

### Technical Problem

The present invention is directed to providing a content sharing method for a relay server that enables business operators operating applications to diversify sales channels by sharing content information without linking with large sales sites.

Objects of the present disclosure are not limited to the above-mentioned objects. That is, other objects that are not mentioned may be obviously understood by those skilled in the art from the following description.

### Technical Solution

One aspect of the present invention provides a content sharing method for a relay server sharing content between application management servers for operating different applications, including: receiving, by the relay server, usable first content information from a first application management server for operating a first application through the first application; transmitting, by the relay server, the first content information to remaining application management servers except for the first application management server from among application management servers registered for content sharing; receiving, by the relay server, content purchase information including a purchase request for the first content information and payment information for purchasing the first content information, which is input through a second application, from a second application management server for operating the second application from among the application management servers; providing, by the relay server, the purchase request for the first content information to the first application management server; receiving, by the relay server, a purchase confirmation of the first content information from the first application management server; and transmitting, by the relay server, the purchase confirmation of the first content information to the second application management server.

The content sharing method may further include: receiving, by the relay server, a purchase price of the first content information by performing an electronic payment corresponding to the payment information based on the content purchase information; and dividing, by the relay server, the purchase price according to a predetermined ratio and providing the divided purchase price to each of the first and second application management servers.

The content sharing method may further include: receiving, by the relay server, the payment information according to the content purchase information; and receiving at least a part of a purchase price according to the payment information as a fee.

The transmitting of the first content information may further include: selecting an application management server providing content identical or similar to the first content information from among the application management servers; and transmitting the first content information to the remaining management servers except for the application management server selected from among the application management servers.

In the transmitting of the first content information, all or part of the first content information may be transmitted corresponding to a content exposure range set by each of the application management servers.

In the transmitting of the first content information, the first content information may be individually transmitted to each application management server in response to a content update cycle set by each of the application management servers.

The transmitting of the first content information may include: determining a language provided from an application operated by each of the application management servers; and translating the first content information into the determined language and transmitting the translated first content information to each application management server.

In the dividing of the purchase price and the providing of the divided purchase price to each of the first and second application management servers, a purchase price exchanged into a currency set by each of the first and second application management servers may be provided.

A reservation confirmation of the first content information may be receivable only from the first application management server.

The content sharing method may further include, after the receiving of the reservation confirmation of the first content, reading, by the relay server, additional content information related to the first content information among pre-stored additional content information, and transmitting the read additional content information to a user terminal that has requested to purchase the first content information.

According to an embodiment, the first content information may include at least one of product sales information, accommodation rental information, facility rental information, air ticket sales information, travel product information, and experience product information.

One aspect of the present invention provides a content sharing method sharing content between application management servers for operating different applications, including: receiving, by a first application management server operating a first application, first content information of a second application, which is provided from the first application, from a relay server; receiving content purchase information including a purchase request for the first content information input through the first application and payment information for purchasing the first content information; providing the purchase request for the first content information to the second application management server; providing at least a part of a purchase price corresponding to the payment information, from which a fee is subtracted, to the management server of the second application; and providing at least a part of the fee to the relay server.

Other specific details of the invention are included in the detailed description and drawings.

### Advantageous Effects

According to a content sharing method for a relay server according to an embodiment of the present invention, it is possible to enable even users who have not installed a specific application to use content provided only by the specific application through applications between which a content sharing agreement has been established.

In addition, according to a content sharing method for a relay server according to an embodiment of the present invention, it is possible to enable administrators of application management servers to diversify sales channels through content information sharing without separately linking with large sales sites.

In addition, according to a content sharing method for a relay server according to an embodiment of the present invention, since content information implemented in a translated language is provided when content information is shared, it is possible to provide content information to users around the world regardless of countries or regions where applications are mainly used.

### DESCRIPTION OF DRAWINGS

FIG. 1 is a schematic block diagram of a content sharing system according to an embodiment of the present invention.

FIG. 2 is a flowchart for describing a content sharing method for a relay server according to an embodiment of the present invention.

FIG. 3 is a flowchart for describing a content sharing method for a relay server according to another embodiment of the present invention.

FIG. 4 is a flowchart for describing a content sharing method for a relay server according to still another embodiment of the present invention.

### MODES OF THE INVENTION

Various advantages and features of the present invention and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless otherwise stated, a singular form includes a plural form in the present specification. Throughout this specification, the terms “comprise” and/or “comprising” will be understood to imply the inclusion of stated constituents but not the exclusion of any other constituents. Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present invention.

Unless defined otherwise, all terms (including technical and scientific terms) used in the present specification have the same meanings commonly understood by those skilled in the art to which the present invention pertains. In addition, terms defined in commonly used dictionaries are not ideally or excessively interpreted unless explicitly defined otherwise.

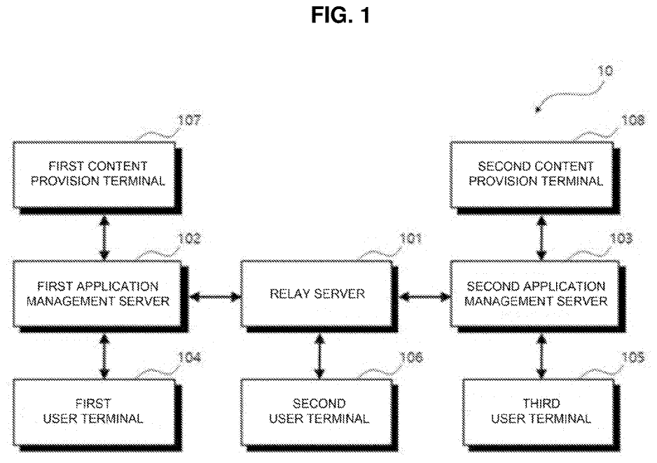

FIG. 1 is a schematic block diagram of a content sharing system according to an embodiment of the present invention.

Referring to FIG. 1, a content sharing system 10 according to the embodiment of the present invention includes a relay server 101 that exchanges data in a network environment using a communication module, and first and second application management servers 102 and 103, first to third user terminals 104 to 106, and first and second content provision terminals 107 and 108.

Each of the first and second application management servers 102 and 103 and the relay server 101 may operate an application that provides content information to users, the first application management server 102 may construct an operating environment for smoothly operating a first application and provide the constructed operating environment to the first user terminal 104, the second application management server 103 may construct an operating environment for smoothly operating a second application and provide the constructed operating environment to the second user terminal 105, and the relay server 101 may construct an operating environment for smoothly operating a third application and provide the constructed operating environment to the third user terminal 106.

Here, the first to third applications may be applications that provide content in the same field, but may also be applications that provide different types of content. For example, the first and second applications may be applications related to accommodation product sales, and the third application may be an application related to clothing sales.

Each of the first and second content provision terminals 107 and 108 may provide content information to the application management server in charge and register the content information in an application operated by the application management server in charge.

When the application management server in charge of the first content provision terminal 107 is the first application management server 102 and the application management server in charge of the second content provision terminal 108 is the second application management server 103, the first content provision terminal 107 may provide content information to the first application management server 102, and the second content provision terminal 108 may provide content information to the second application management server 103.

For example, when the first content provision terminal 107 generates product information for accommodation in a hotel in Seoul and provides the generated product information to the first application management server 102, the first application management server 102 may register corresponding hotel accommodation product information in the first application, and when the second content provision terminal 108 generates air ticket sales information and provides the generated air ticket sales information to the second application management server 103, the second application management server 103 may register the corresponding air ticket sales information in the second application.

When accommodation products for a first accommodation are registered only in the first application and accommodation products for the first accommodation are not registered in the second application, the user of the second user terminal 105 may not purchase accommodation products for the use of the first accommodation unless the first application is separately installed.

In this way, in order to solve the user's inconvenience of content information only being registered in a specific application, the relay server 101 may serve as an intermediary to share content information registered only in a specific application with other applications.

Specifically, the relay server 101 may enter into a separate content sharing agreement with the application management server, and mediate content sharing between application management servers in a content sharing agreement. When a new product is registered in an application, the application management server that has established the content sharing agreement may provide content information related to the new product to the relay server 101 so that the new product may be registered even in applications operated by other application management servers.

When the relay server 101 receives content information from any one of the application management servers that have established the content sharing agreement, the relay server 101 may determine whether to provide the content information to other application management servers. In this case, the relay server 101 may select an application management server that provides content identical or similar to the content information and provide content information to only the remaining application management servers except for the selected application management server from among the application management servers.

Since there is a risk of causing confusion to users when identical or similar products are registered in more than once in one application, the relay server 101 may provide the content information only to the application management servers other than the selected application management server from among the application management servers in order to prevent this risk.

For example, when a new shoe product is registered for sale in an application operated by the first application management server 102, the first application management server 102 may provide content information related to the new shoe product to the relay server 101, and the relay server 101 may determine whether the shoe product information is registered in the second application management server 103 based on the content information to provide the content information to the second application management server 103 only when there is no shoe product information identical or similar to the shoe product information.

When the second application management server 103 receives the content information related to new shoe product information from the relay server 101, the second application management server 103 may register a new shoe product for sale in the second application based on the content information. Accordingly, the user of the second user terminal 105 may use the content related to the new shoe product through the second application without separately installing the first application.

According to the embodiment, when the first and second application management servers 102 and 103 enter into the content sharing agreement with the relay server 101, the relay server 101 may transmit all or part of content information to the application management server in response to the set content exposure range.

For example, the first application management server 102 may set the content exposure range by receiving all information about content information, and the second application management server 103 may set the content exposure range by receiving only some information about content information. In this case, the content information provided to the second application management server 103 through the relay server 101 is partially transmitted in a restricted state, but all content information provided to the first application management server 102 through the relay server 101 may be transmitted without limitation.

In one embodiment, the exposure and reception range of the content may be variously set according to the user's selection. For example, a user may display products provided from other applications in his/her own application without restriction, and may perform a selection to exclude products that may compete with products provided from his/her own application. A user may set products of other applications displayed through his/her own application through one or more filter settings. In this case, when his/her own application product is sold through application usage fees or other applications depending on the type and number of filters applied, an absolute value or ratio of a fee to be paid may be adjusted differently. For example, the fee or fee rate may increase proportionally according to the number of filters.

As another example, a user may set the range of products exposed through other applications among products sold through the user's own application. For example, a special price product may be exposed only through the user's own application, and only regular price products may be shared through other applications.

In this case, a price difference between an exclusive product supplied through the user's own application and regular price products supplied through other applications is calculated, and a fee corresponding to a predetermined percentage of the calculated price difference may be set to be paid to the relay server 101 when selling regular price products, but embodiments are not limited thereto.

According to another embodiment, the relay server 101 may provide content information in real time to application management servers that have entered into a content sharing agreement whenever content information is received from the application management server.

In addition, the relay server 101 may provide content information according to a content update cycle to an application management server in which a content update cycle is set separately. This is to update the content information at predetermined time intervals because the content information registered in the application may change in real time and cause confusion to a user.

For example, the first application management server 102 may not set the content update cycle, and the second application management server 103 may set the content update cycle to be updated every 24 hours at midnight. Accordingly, when the content information is received from any one application management server, the relay server 101 may transmit the content information to the first application management server 102 in real time, but transmit the content information to the second application management server 103 at midnight.

According to another embodiment, the relay server 101 may determine languages provided from applications operated by application management servers, translate the content information into the determined languages, and provide the translated content information. Since the languages provided from each application may be different from each other, the content information provided in the languages not provided from the application may cause confusion to users. Accordingly, the relay server 101 may determine a language for scanning set by each application management server and translate the content information into the languages used in the applications.

For example, the first application operated by the first application management server 102 may use the Korean language, and the second application operated by the second application management server 103 may use the Arabic language. When the relay server 101 receives the content information from the first application management server 102 and shares the received content information with the second application management server 103, the relay server 101 may translate the Korean language including the content information into the Arabic language and transmit the translated content information to the second application management server 103.

As such, since the relay server 101 according to the embodiment of the present invention provides the content information implemented in the translated language when the content information is shared, the content information may be provided to users around the world regardless of countries or regions where the application is mainly used.

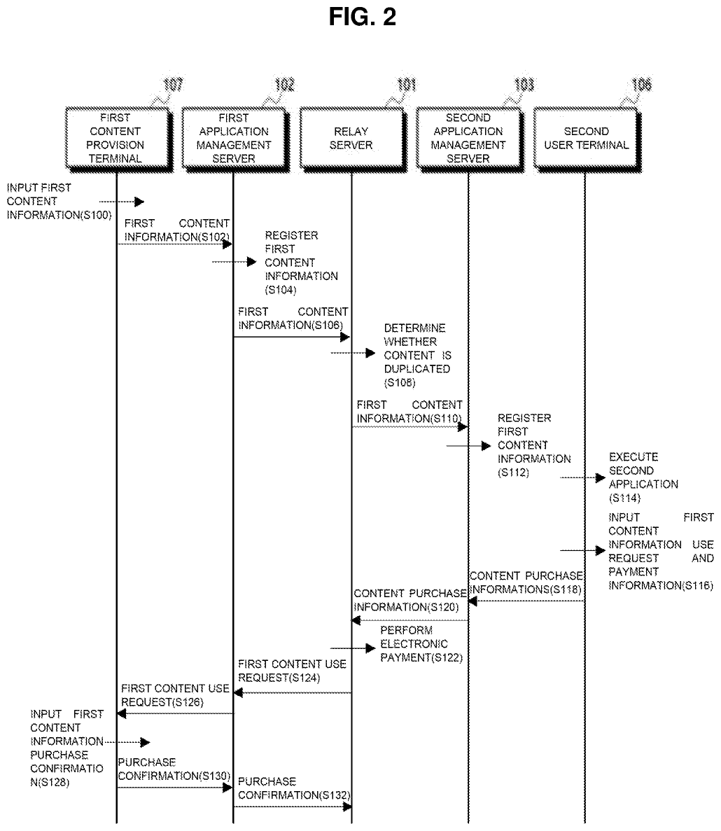

When a user purchases content information shared and registered in an application, the relay server 101 may perform electronic payment by receiving the user's payment information from the application management server. Even if the shared content information is registered in the application, the corresponding content information is not directly registered in the application by the content provision terminal, but the content information provided from the relay server 101 is registered by the application management server. Therefore, when a user requests the purchase of the shared content information, the relay server 101 may transmit the purchase request to the application management server that has shared the content information in order to provide the purchase request to the content provision terminal that has provided the content information. A detailed description thereof will be described below with reference to FIG. 2.

Meanwhile, in FIG. 1, only the first and second application management servers 102 and 103 are illustrated for convenience of description, but embodiments are not limited thereto, and the relay server 101 may serve as an intermediary to share the content information between a plurality of application management servers that operate different applications.

In addition, each of the first to third user terminals 104 to 106 and the first and second content provision terminals 107 and 108 may be any one of a personal computer (PC), a smart phone, a tablet PC, a mobile internet device (MID), an Internet tablet, an Internet of things (IoT) device, an Internet of everything (IoE) device, a desktop computer, a laptop computer, a workstation computer, a wireless broadband Internet (WiBro) terminal, and a personal digital assistant (PDA), but is not limited thereto.

In addition, the first and second application management servers 102 and 103 and the relay server 101 are devices capable of hosting an online network and specifying a network address, and may access a separate database to perform the content sharing method and write or read data.

FIG. 2 is a flowchart for describing a content sharing method for a relay server according to an embodiment of the present invention.

Referring to FIG. 2, the first content provision terminal 107 may receive the first content information from a user in order to register content in the first application (S100), and transmit the input first content information to the first application management server 102 operating the first application (S102).

According to an embodiment, the first content information may include at least one of product sales information, accommodation rental information, facility rental information, air ticket sales information, travel product information, and experience product information.

The first application management server 102 may register the first content information in the first application so that the first content information is displayed on the first user terminal 104 in which the first application is installed (S104), and may transmit the first content information to the relay server 101 for the content information sharing (S106).

The relay server 101 may select an application management server that provides content identical or similar to the content information in order to determine whether to provide the first content information received from the first application management server 102 to other application management servers, thereby determining whether the content is duplicated (S108).

When the content information identical or similar to the first content information is not registered in the second application management server 103, the relay server 101 may transmit the first content information to the second application server (S110).

The second application management server 103 may register the first content information in the second application (S112). In this case, the first content information registered in the second application does not include any information related to the first application, and is displayed as being managed by the second application like other content information registered in the second application.

More specifically, a connection means such as a link or an icon that may be connected to the first application may be displayed in the second application. In this case, when a user selects the corresponding connection means, the first application may be executed inside the second application or through an external link.

In one embodiment, the first application to be executed may provide functions provided from the first application (e.g., product sales, service reservation, etc.) and corresponding products, and a user may also purchase the provided products or make a reservation. However, according to an embodiment, a trademark or logo related to the operator of the first application may not be displayed on a screen of the first application accessed through the second application at all. These functions may be modified and provided by the operator of the first application in the first application itself for use in a link or in-app or at a provided API level, and according to the embodiment, when the first application is executed within the second application, the second application may operate to automatically hide the logo or source indication of the first application and output the logo or source indication on the screen. For example, the second application may operate the first application within the app and obtain information about a first page of the first application. The second application may scan the first page and detect images and text identical or similar to the service logo of the first application. The second application may replace the detected image and text with the logo image and text of the second application or may perform blinding on the logo image and text. The second application may display the first page of the first application on which processing is completed. Thereafter, when the input for each page of the first application is performed and connected to other pages such as the second page, the second application may perform a modification operation on the pages of the first application and then display the modified pages, and authority for this may be received in advance.

A user may purchase a product or reserve a service on the page of the first application displayed in the second application, and at least a part of the resulting revenue may be provided to the second application user as a fee.

The second user terminal 105 executes the second application to receive, from a user, content purchase information that includes a use request for purchasing the first content information and payment information (S114 and S116), and transmit the content purchase information to the second application management server 103 (S118).

According to the embodiment, the second application management server 103 may perform electronic payment for purchasing the first content and provide a purchase approval result to the relay server 101.

The relay server 101 may receive the content purchase information from the second application management server 103 (S120), and receive a purchase price by performing electronic payment corresponding to the payment information based on the payment information included in the content purchase information (S122). The relay server 101 may perform the electronic payment by linking with a separate financial server, but is not limited thereto, and may directly receive the purchase price from the user of the second user terminal 105 based on the payment information.

The relay server 101 may receive the purchase price and then generate the use request of the first content and transmit the generated use request of the first content to the first application management server 102, and the first application management server 102 may transmit the use request of the first content to the first content provision terminal 107 in which the first content information is registered.

According to the embodiment, the first application management server 102 may acquire the purchase price according to the use request of the first content, and provide at least a part of the purchase price, from which a fee is subtracted, to the second application management server 103. Also, by providing at least a part of the fee to the relay server 101, the servers may distribute the fee to each other.

The first content provision terminal 107 may receive the purchase confirmation of the first content information from a user (S128), and the information related to the purchase confirmation may be transmitted to the relay server through the first application management server 102 (S130 and S132).

That is, the user of the first content provision terminal 107 may determine an identity of a user who has requested the first content information based on the use request of the first content, and input the purchase confirmation of the first content information for product sales confirmation, accommodation rental confirmation, facility rental confirmation, air ticket sales confirmation, travel product sales confirmation, experience product sales confirmation, etc., to the first content provision terminal 107.

The relay server 101 may transmit the purchase confirmation to the second application management server 103, and the second user terminal 105 may receive the purchase confirmation from the second application management server 103.

Through this process, the user of the second user terminal 105 in which the first application is not installed may also use the first content information through the pre-installed second application, and the administrators of the application management server may diversify sales channels through the content information sharing without separately linking with large sales sites.

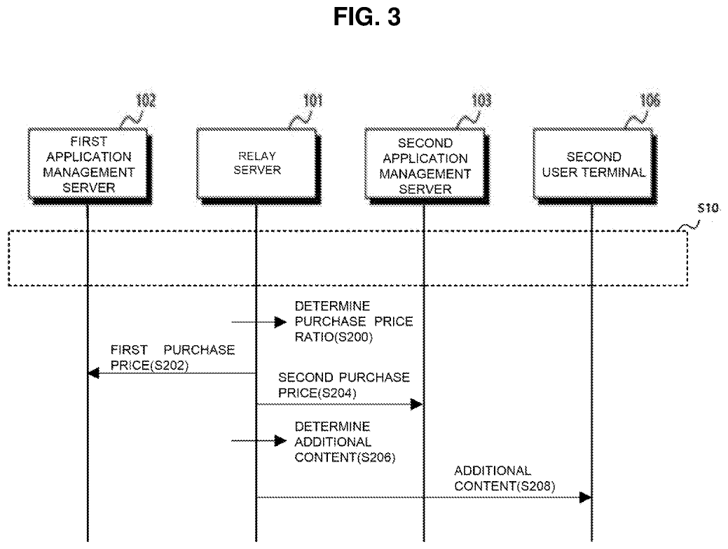

FIG. 3 is a flowchart for describing a content sharing method for a relay server according to another embodiment of the present invention.

In FIG. 3, some operations (S10) of the content sharing method for a relay server described in FIG. 2 are referred to in order to avoid redundant description.

Referring to FIG. 3, the relay server 101 may determine a purchase price ratio to divide the purchase price provided as the first content information is paid (S200).

The ratio at which the purchase price is divided is determined when the content sharing agreement is executed between the relay server 101 and the application management servers, and the relay server may divide the purchase price into a first purchase price for the first application management server 102 registering the first content information for the first time according to a predetermined ratio, a second purchase price for the second application management server 103 receiving the content purchase information from the user through the application, and brokerage of the relay server 101.

The relay server 101 may provide the first purchase price to the first application management server 102 (S202) and may provide the second purchase price to the second application management server 103 (S204).

The relay server 101 may determine additional content related to the first content information among the pre-stored additional content information (S206), and may provide the determined additional content to the second user terminal 105 (S208).

For example, when the first content information is a product related to local travel, the relay server 101 may read a local currency that may be used in the corresponding area and discount coupons that may be used at local stores and provide the read local currency and discount coupons to the second user terminal 105.

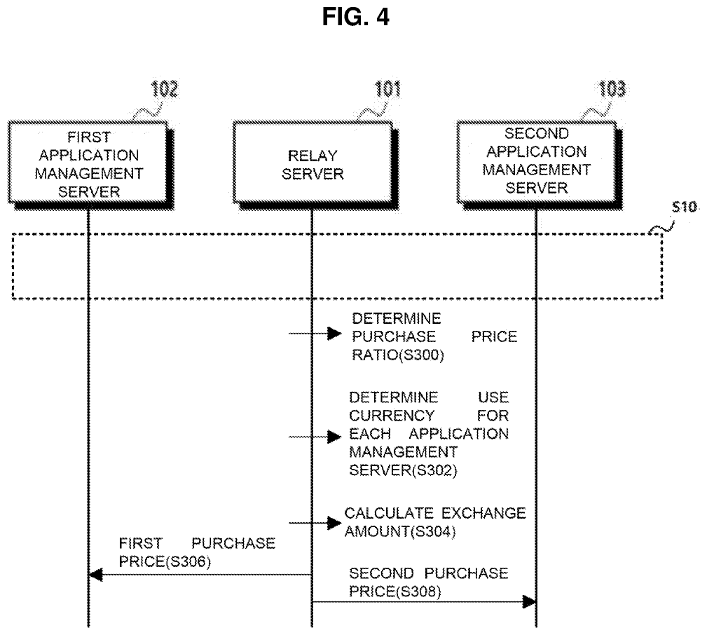

FIG. 4 is a flowchart for describing a content sharing method for a relay server according to still another embodiment of the present invention.

In FIG. 4, some operations (S10) of the content sharing method for a relay server described in FIG. 2 are referred to in order to avoid redundant description.

Referring to FIG. 4, the relay server 101 may determine a purchase price ratio to divide the purchase price provided as the first content information is paid (S300).

The relay server 101 may determine a used currency set for each application management server in order to provide an amount exchanged for the currency set by the application management server as the purchase price (S302), and exchange the purchase price for the determined use currency (S304). The used currency may be set by the application management server when the content sharing agreement is executed, and the used currency may be different for each application management server.

For example, when the first application management server 102 sets won and the second application management server 103 sets dollars, the relay server 101 may exchange the first purchase price for won and provide the won to the first application management server 102, and exchange the second purchase price for dollars and provide the dollars to the second application management server 103.

The relay server 101 may provide the first purchase price to the first application management server 102 (S306) and may provide the second purchase price to the second application management server 103 (S308).

According to an embodiment, the relay server 101 may generate additional content based on a payment history of a user using the first application, GPS information of a user's mobile terminal, and information on content purchased or reserved by a user. For example, as a user completes payment for the content, payment information about additional content may be transmitted to the first application management server 102 through the communication module so that the additional content is provided along with the content. The payment history may include a history of payments and reservations performed by a user in the past. For example, the content information may include various types of information, such as a destination, a travel period, a departure and arrival time, and a location of content corresponding to travel products. For example, the additional content may be a coupon, and may be related to various services that may be provided together with coffee, food, hotel, and service industry (tax accountant, lawyer, etc.) content. For example, when a user is scheduled to depart from Gimpo Airport, a coupon for a cafe located in Gimpo Airport may be provided to the user who has purchased content which is a travel product. Alternatively, a coupon for a cafe close to the user's location provided by the cafe where the user has most often purchased coffee may be provided based on the user's GPS information.

In one embodiment, the relay server 101 may obtain a user's traffic line information from the user's home (or other specific departure location) to Gimpo Airport, and selectively provide a coupon based on the user's traffic line information. For example, the relay server 101 may present a user with a coupon that may be used at a cafe (or other business office) located in Gimpo Airport, and a coupon that may be used in at least one cafe located on a traffic line along which a second user moves to Gimpo Airport.

When a coupon is presented to a user, a notification including the corresponding information may be provided to cafes related to the presented coupons. In this case, each cafe may present content of coupons or discount rates in order to bring users to their own cafes, and the corresponding information may be provided to the users.

In one embodiment, each cafe may use a coupon content confirmation function that allows it to confirm content of coupons provided by other cafes. According to the embodiment, the coupon content confirmation function may be provided for a fee, but is not limited thereto.

In one embodiment, each cafe may acquire other traffic line information not including itself. A cafe may use a challenge function to provide information about itself and a coupon to a user corresponding to the corresponding traffic line information in order to bring a user corresponding to other traffic line information there. The cost required to use the challenge function may be divided into the cost of using the function and the cost that a user pays when the user visits the cafe and uses a coupon according to the function use. For example, a cafe may pay a predetermined usage fee for using the challenge function, and when a user visits the cafe and uses a coupon accordingly, the user may pay an additional usage fee.

Each usage fee is paid to a service provider according to the disclosed embodiment, and the service provider may obtain advertising and fee revenue through competition between various services located on a user's movement line. According to an embodiment, the relay server 101 may determine a first range and a second range of a plurality of types of first content to be provided through each of the first application and the second application, respectively, based on a company's policies and bylaws, etc., operating the challenge function. In this case, the first range and the second range may be different from each other. The relay server 101 may transmit the first range of the plurality of types of first content to the first application management server 102 and transmit the second range of the plurality types of first content to the second application management server 103. In this way, the relay server 101 may determine content not to be provided to other external servers according to various established standards such as a company's policies and bylaws, and selectively provide the content to other external servers. Operations of the method or algorithm described with reference to the embodiment of the present invention may be directly implemented in hardware, in software modules executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a compact disc read-only memory (CD-ROM), or in any form of computer-readable recording medium known in the art to which the invention pertains.

Although exemplary embodiments of the present invention have been described with reference to the accompanying drawings, those skilled in the art to which the present disclosure belongs will appreciate that various modifications and alterations may be made without departing from the spirit or essential features of the present invention. Therefore, it is to be understood that the embodiments described hereinabove are illustrative rather than being restrictive in all aspects.

1. A content sharing method for a relay server sharing content between application management servers for operating different applications, the content sharing method comprising:
receiving, by the relay server, usable first content information from a first application management server for operating a first application through the first application;
transmitting, by the relay server, the first content information to remaining application management servers except for the first application management server from among application management servers registered for content sharing;
receiving, by the relay server, content purchase information including a purchase request for the first content information and payment information for purchasing the first content information, which is input through a second application, from a second application management server for operating the second application from among the application management servers;
providing, by the relay server, the purchase request for the first content information to the first application management server;
receiving, by the relay server, a purchase confirmation of the first content information from the first application management server; and
transmitting, by the relay server, the purchase confirmation of the first content information to the second application management server.

2. The content sharing method of claim 1, further comprising:
receiving, by the relay server, a purchase price of the first content information by performing an electronic payment corresponding to the payment information based on the content purchase information; and
dividing, by the relay server, the purchase price according to a predetermined ratio and providing the divided purchase price to each of the first and second application management servers.

3. The content sharing method of claim 1, further comprising:
receiving, by the relay server, the payment information according to the content purchase information; and
receiving at least a part of a purchase price according to the payment information as a fee.

4. The content sharing method of claim 1, wherein the transmitting of the first content information further includes:
selecting an application management server providing content identical or similar to the first content information from among the application management servers; and
transmitting the first content information to the remaining management servers except for the application management server selected from among the application management servers.

5. The content sharing method of claim 1, wherein, in the transmitting of the first content information, all or part of the first content information is transmitted corresponding to a content exposure range set by each of the application management servers.

6. The content sharing method of claim 1, wherein, in the transmitting of the first content information, the first content information is individually transmitted to each application management server in response to a content update cycle set by each of the application management servers.

7. The content sharing method of claim 1, wherein the transmitting of the first content information includes:
determining a language provided from an application operated by each of the application management servers; and
translating the first content information into the determined language and transmitting the translated first content information to each application management server.

8. The content sharing method of claim 7, wherein, in the dividing of the purchase price and the providing of the divided purchase price to each of the first and second application management servers, a purchase price exchanged for a currency set by each of the first and second application management servers is provided.

9. The content sharing method of claim 1, wherein a reservation confirmation of the first content information is receivable only from the first application management server.

10. The content sharing method of claim 1, further comprising, after the receiving of the reservation confirmation of the first content, reading, by the relay server, additional content information related to the first content information among pre-stored additional content information, and transmitting the read additional content information to a user terminal that has requested to purchase the first content information.

11. A content sharing method sharing content between application management servers for operating different applications, the content sharing method comprising:
receiving, by a first application management server operating a first application, first content information of a second application, which is provided from the first application, from a relay server;
receiving content purchase information including a purchase request for the first content information input through the first application and payment information for purchasing the first content information;
providing the purchase request for the first content information to the second application management server;
providing at least a part of a purchase price corresponding to the payment information, from which a fee is subtracted, to the management server of the second application; and
providing at least a part of the fee to the relay server.

12. A computer program stored in a computer-readable recording medium to perform the content sharing method for a relay server of claim 1 in combination with a computer as hardware.
